(19) United States
(12) Patent Application Publication
(10) Pub. No.: US 2007/0146866 A1
(43) Pub. Date: Jun. 28, 2007

(54) OPTICAL CONVERTER

(75) Inventor: Oliver Wright, SAPPORO-SHI (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JAPAN SCIENCE AND TECHNOLOGY AGENCY, KAWAGUCHI-SHI (JP)

(21) Appl. No.: 10/594,324

(22) PCT Filed: Mar. 30, 2005
(86) PCT No.: PCT/JP05/06012

§ 371 Date: Jan. 19, 2007

(30) Foreign Application Priority Data
Mar. 31, 2004 (JP) 2004-102906

(51) Int. Cl. G02F 1/35

(52) U.S. Cl. 359/332

(57) ABSTRACT

A device for conversion or amplification of the frequency of optical radiation, both continuous wave and pulsed, with a cheap and compact structure. The device includes a multilayer structure including a metal layer and a dielectric layer, and a transparent dielectric material disposed on the top layer of the multilayer structure. An incident beam is coupled by a coupling device, utilizing a specific surface plasmon-polariton mode, and thereby output beams reflected from a sample are modulated or amplified.

### TECHNICAL FIELD

The present device can be applied to the modulation of optical radiation, the amplification of optical radiation or the conversion of the frequency of optical radiation in a wide range of applications.

As a frequency-converter or amplifier it can be used in scientific applications to increase the intensity or broaden the range of optical frequencies emitted by lasers, both continuous and pulsed, and allows the tuning of the output frequency. It can also be used in applications in which supercontinuum generation from ultrashort pulsed lasers is required. Such a white light supercontinuum can provide a high-quality broadband spectrum of optical frequencies for a optical coherence tomography or be useful for ultrashort light pulse generation and spectroscopy.

As an optical modulator it can be used in switching applications, including ultrafast switching involving the use of picosecond or femtosecond optical light pulses. An example of use is the use as a optical chopper of continuous wave radiation in scientific applications. Another example of use is in telecommunications for encoding data that may be transmitted through a fibre optic waveguide.

There are also many other possible industrial applications of the present invention, such as applications in laser spectroscopic analysis, laser ranging systems, remote sensing and imaging. Medical applications and laser power delivery applications are also served by this device. It can be used as a compact and cheap alternative to produce high-performance sources of tunable, coherent light that can be modulated, resulting in wide application in science, industry and the environment.

### BACKGROUND ART

The present invention relates to a device for the conversion of optical radiation for converting, modulating or amplifying an incident beam or beams of optical radiation by means of an optical parametric interaction due to a third order nonlinear optical effect, wherein the resonant interaction between two surface plasmon-polaritons, which is necessary for efficient conversion to one frequency-upshifted and one frequency-downshifted surface plasmon-polariton, is achieved by a novel multilayer structure.

As a conventional technique for optical frequency conversion or optical amplification by means of nonlinear optical effects, gas lasers or solid state lasers have been experimentally employed in such a manner that the optical radiation therefrom is incident on nonlinear optical crystals, waveguides or periodically patterned media to obtain harmonic generation or optical parametric oscillation at shifted optical frequencies.

When using nonlinear bulk crystals for optical frequency conversion or optical parametric oscillation it is essential to use a material which meets the optical phase matching conditions for optical nonlinear generation. The relatively low conversion efficiencies obtained require either large optical intensities or the use of long crystals. The direction and polarization of incident light and the axis of the crystal must be strictly adjusted, as must be the temperature. For reliable devices such units become large and expensive, and are therefore used only in limited institutions, such as factories, universities, and laboratories.

When using optical waveguides or periodically patterned media in such applications to improve efficiency, it is difficult to produce a device having dimensions coincident with the theory, with satisfactory reproducibility. These devices are therefore expensive and applications are limited.

As a conventional technique for optical modulation, acoustic optic modulators, electro-optic modulators or spatial light modulators have been proposed. Such optical modulators are widely used in niche scientific and telecommunications applications, but they are bulky and lossy. Being based on electrical inputs they are not suitable for ultrahigh frequency switching applications on picosecond and femtosecond timescales. More promising for such ultrahigh frequency applications are all-optical techniques based on ultrafast nonlinear optical effects, for example in semiconductor heterostructures or dual core fibres. However, large coupling regions and high optical powers are needed to achieve modulation when using these technologies. A drastic reduction of both the size and the optical power consumption of conventional photonic devices based on nonlinear effects may be possible using the strong confinement of the electromagnetic field. One proposal for such confinement is the use of photonic crystal structures. However, these structures are expensive and subject to strict geometrical constraints in more than one dimension.

A surface plasmon-polariton is a combined mode of electromagnetic waves and bulk plasma which propagates for example along the interface between two materials having dielectric constants of opposite sign, for example a metal and a dielectric layer. Unless otherwise stated the word ‘dielectric constant’ refers to the real part of the complex dielectric constant in this patent. Surface plasmon-polaritons are also referred to as surface plasmons. In this patent we also use the term ‘surface plasmon-polariton’ to include the case in which the mode localized inside a multilayer structure. In isotropic materials the polarization of surface plasmon-polaritons is transverse magnetic with the electric field perpendicular to the material interface. A unique feature of surface plasmon-polaritons is that much of their energy is concentrated near the interface, leading to large enhancements of the electric field there and to optical nonlinear effects over sub-millimetre or millimetre propagation lengths. In addition, the fabrication of structures that support surface plasmon-polaritons requires only the deposition of thin metal and dielectric films, leading to simple, compact and inexpensive devices.

These advantageous features lead to the proposal that surface plasmon-polaritons could be used to achieve optical frequency conversion, for example as described in the following patent document 1 or the following patent document 2. However, these devices are only suitable for harmonic generation, a non-resonant process with limited efficiency, allowing only integral multiples of the incident optical frequency to be produced rather than tunable or broadband optical radiation. Applications of this surface plasmon-polariton harmonic generation method are therefore also limited.

It has also been proposed that surface plasmon-polaritons could be used in optical modulators based on the electro-optic modulation, for example, as described in the following patent document 3 and the following patent document 4. In an optical modulator, however, the use of electric signals and resultant capacitive effects prevents efficient optical modulation on picosecond and femtosecond timescales. All-optical modulators based on surface plasmon-polaritons have been proposed, such as those utilizing the photorefractive effect as described in the following patent document 5. However, such devices do not allow the possibility of optical gain at the same time as optical modulation, and suffer from losses.

Interactions between surface plasmon-polaritons are known to be extremely strong because of the extreme confinement of the associated electromagnetic fields. However there is a severe limitation on such interactions from the dual requirements of the conservation of plasmon-polariton energy [symbol] ω and wave vector k, where [symbol] is Planck's constant. In this patent the symbol k refers to the real part of the complex wave vector in the direction parallel to the layers of the multilayer structure in the direction of propagation.

FIG. 1 shows the shape of a typical surface plasmon-polariton dispersion relation ω(k) at a semi-infinite metal surface, where ω is the angular frequency and k is the real part of the complex wave vector in the direction parallel to the layers of the multilayer structure. An example of an interaction process forbidden according to the conservation of surface plasmon-polariton energy and wave vector is shown by the transitions marked by the crossed arrows. The open circles represent the starting points for the transitions and the closed circles represent the finishing points. The photon dispersion relation is shown by the dashed line. The two-dimensional surface plasmon-polariton frequency ωₚ/\sqrt{1+ε} is shown by the dotted line, where ε is the dielectric constant of the medium above the metal and ωₚ is the bulk plasmon frequency of the metal.

The shape of a typical surface plasmon-polariton dispersion relation ω(k) at a semi-infinite metal surface, as shown in FIG. 1, does not allow the parametric interaction in which two surface plasmon-polaritons at angular frequencies ωₐ and ω_{b} mutually interact to give plasmons at
ωₐ(k+q)=ωₐ(k)+δ, (1)
ω_{b}(k−q)=ω_{b}(k)−δ, (2)
where the wave vectors k, k+q and k−q are all collinear and parallel to the surface, δ is a particular angular frequency shift, and q>0 is a constant real wave vector. An example of such a forbidden process for the particular case of ωₐ=ω_{b}=ω₀ is shown by the transitions marked by the crossed arrows in FIG. 1. Essentially the typical dispersion relation for surface plasmon-polaritons couples the photon dispersion relation, shown dashed in FIG. 1, with the two-dimensional surface plasmon-polariton frequency ωₚ/\sqrt{1+ε}, shown by the dotted line in FIG. 1, where ε is the dielectric constant of the medium above the metal and ωₚ is the bulk plasmon frequency of the metal. The resulting dispersion relation has a gradient, the group velocity, that monotonically decreases as k increases, thus forbidding the parametric interaction process between two surface plasmon-polaritons because the dual requirements of energy and wave vector conservation cannot be satisfied. The same restriction applies when ωₐ≠ω_{b}.

One way around this restriction is to utilize localized surface plasmon-polaritons on metallic nanoparticles, as revealed for example in the following patent document 6 or the following non-patent document 1, for which all wave vectors are present allowing the parametric interaction to occur. However in this case no resonance condition exists, and non-radiative losses are rather high.

A similar problem restricts the parametric interaction between excitons in semiconductors.

FIG. 2 shows the shape of a typical exciton dispersion relation ω(k) in a semiconductor. An example of an interaction process forbidden according to the conservation of exciton energy and wave vector is shown by the transitions marked by the crossed arrows. The open circles represent the starting points for the transitions and the closed circles represent the finishing points.

As shown in FIG. 2, the excitons in semiconductors typically exhibit a quadratic dispersion relation, where the group velocity monotonically increases with wave vector k. As was done in the case of FIG. 1, a forbidden process of the type described by the analogue of equations (1) and (2) with ωₐ=ω_{b} for excitons is shown by the transitions marked by the crossed arrows in FIG. 2. Recently it was shown to be possible to modify the dispersion relation of excitons by embedding them in photonic nanostructures, in such a way as to permit the parametric interaction process to occur, as described in the following non-patent document 2. The use of semiconductor microcavities allows the existence of exciton-polaritons, made up of coupled excitons and photons. The dispersion relation is deformed compared to that of excitons and elicits a giant nonlinear optical response suitable for ultrafast optical amplification, optical modulation and optical parametric oscillation, as described in the following non-patent document 3. This giant nonlinear optical response was obtained by exploiting processes involving the optically nonlinear conversion of two degenerate exciton-polaritons.

FIG. 3 shows the shape of a typical exciton-polariton dispersion relation ω(k) in a semiconductor microcavity. An example of an interaction process allowed according to the conservation of exciton energy and wave vector is shown by the transitions marked by the arrows. The open circles represent the starting points for the transitions and the closed circles represent the finishing points.

The dispersion relation of exciton-polaritons, as shown in FIG. 3, naturally containing a point of inflection, automatically permits such resonant optical parametric interactions with huge optical gains up to 1000 or above. An example of such a permitted process of the type described by the analogue of equations (1) and (2) with ωₐ=ω_{b} for exciton-polaritons is shown by the transitions shown by the arrows in FIG. 3. Moreover, because of the boson statistics of exciton-polaritons, this process is enhanced by an amount approximately proportional to the occupation of the final state of the interaction of the exciton-polaritons, hence the efficiency of the conversion process can be greatly enhanced. The nanostructures involved, however, require a very large number of layers to confine the exciton-polaritons and must be made with single-crystal semiconductor layers with great precision. In addition, operation at room temperature or above is not possible owing to exciton-polariton ionization. These structures are therefore not suitable for wide application outside factories, universities, and laboratories.

It is evident then that the use of surface plasmon-polaritons for optical parametric conversion processes that allow optical modulation, optical amplification or optical frequency conversion in a wide range of applications has been limited by the nature of the surface plasmon-polariton dispersion relation. Normally no third order nonlinear interactions between two degenerate surface plasmon-polaritons, essential for optical parametric processes with tunable frequency output, are possible because of the constraints of simultaneous energy and wave vector conservation.
Patent Document 1: U.S. Pat. No. 5,011,250
Patent Document 2: U.S. Pat. No. 5,073,725
Patent Document 3: U.S. Pat. No. 6,034,809
Patent Document 4: U.S. Pat. No. 6,504,651
Patent Document 5: U.S. Pat. No. 6,611,367
Patent Document 6: U.S. Pat. No. 5,023,139
Non-patent Document 1: D. J. Bergman et al. Physical Review Letters 90, 027402-1-4, 2003
Non-patent Document 2: P. G. Savvidis et al. Physical Review Letters 84, 1547-1550, 2000
Non-patent Document 3: J. J. Baumberg et al. Physical Review B 62, R16247-R16250, 2000

### DISCLOSURE OF INVENTION

The present invention aims to provide a means to achieve the conversion or amplification of the frequency of optical radiation, both continuous wave and pulsed, with a cheap and compact structure, and to provide a means to tune the frequency of the output radiation in a simple way. Moreover the invention aims to provide a means to achieve the generation of a broadband spectrum of optical frequencies from a pulsed laser, for example a supercontinuum. Furthermore, the invention aims to provide a means to modulate optical radiation from low frequencies up to ultrahigh frequencies.

It is the object of this invention to provide an improved device for conversion of the frequency of optical radiation.

It is the further object of the invention to provide such a device that does not require crystals or waveguide structures, but only requires a series of layers.

It is the further object of the invention to provide such a device that does not require semiconductor heterostructures.

It is the further object of the invention to provide such a device that can provide a source of tunable optical radiation.

It is the further object of the invention to provide such a device that can provide such source of broadband optical radiation of variable optical bandwidth.

It is the further object of the invention to provide such a device that can provide an efficient conversion efficiency by exploiting the enhanced electric fields in the region of surfaces and interfaces associated with surface plasmon-polaritons.

It is the further object of the invention to provide such a device that can provide a means to amplify optical radiation.

It is the further object of the invention to provide such a device that can provide a means to modulate optical radiation.

It is the further object of the invention to provide such a device that can provide a means to achieve simultaneous optical modulation and optical amplification.

It is the further object of the invention to provide such a device that can provide a means to achieve simultaneous optical modulation and optical frequency conversion.

It is the further object of the invention to provide such a device that can provide a means to achieve simultaneous optical modulation, optical frequency conversion and optical amplification.

It is the further object of the invention to provide such a device that can provide an ultrahigh frequency response on picosecond or femtosecond timescales.

It is the further object of the invention to provide such a device that can operate at room temperature.

The invention results from the realization that a truly effective device for conversion of the frequency of optical radiation should be simple, compact, and low cost, while at the same time satisfying the requirement for tunability and the possibility of achieving optical gain, optical modulation and the generation a wide range of optical frequencies, including a broadband spectrum of optical frequencies.

This invention features a device in which an incident beam or beams of input optical radiation is incident on a multilayer structure. The input optical radiation is typically chosen in the optical wavelength region 10 nm to 1000 microns. It can be derived from a continuous wave or pulsed optical source, typically from a laser. Examples of lasers that can be used are gas, solid-state or semiconductor lasers. For the case of a pulsed optical source the optical pulses have a typical duration of 0.002 ps to 20 μs. The multilayer structure contains one or more layers with a negative dielectric constant, typically being metallic, and one or more other layers with a positive dielectric constant and typically being dielectrics. This structure is designed so that the multilayer structure supports one or more surface plasmon-polariton modes. At least one of the dispersion relations of the surface plasmon-polariton modes has the special property that it allows the optical parametric interaction due to a third order nonlinear optical effect of two surface plasmon-polaritons of angular frequencies ωₐ and ω_{b}, resulting in the conversion to a frequency-upshifted surface plasmon-polariton with angular frequency ωₐ+δ and a surface plasmon-polariton, downshifted by an equal amount, with angular frequency ω_{b}−δ, where δ is a particular angular frequency shift that may take a range of values. When ωₐ=ω_{b}=ω₀ the angular frequencies ω₀, ω₀+δ and ω₀−δ are analogous to the pump, idler and signal frequencies in the field of conventional nonlinear optics. This third order nonlinear optical effect can arise because one or more of the layers in the multilayer structure possesses a third order nonlinear optical susceptibility.

The multilayer structure can typically consist of a combination of parallel, planar metal and dielectric layers, although it is also possible to include other materials such as semiconductors in the design. A particular structure with the required characteristics can be made with five layers, consisting of four dielectric layers placed in a symmetric configuration two either side of a metal layer. The typical thickness of the layers can ranges from 2 nm to 20 μm. One of these layers or a sixth layer can be added as a substrate that is substantially thicker in order to support the structure. With this type of special structure with carefully chosen materials, dielectric constants and layer thicknesses, the dispersion relation of a surface plasmon-polariton mode substantially confined in the central metal layer can be tailored to allow the resonant optical parametric interaction of two surface plasmon-polaritons at frequencies ωₐ and ω_{b}, resulting in the conversion to two surface plasmon-polaritons at angular frequencies ωₐ+δ and ω_{b}−δ, where δ can take a range of values. One way that this interaction can be enabled in the case ωₐ=ω_{b} is to arrange that the dispersion curve of the surface plasmon-polaritons exhibits a point of inflection by such a judicious design of the multilayer structure.

The input optical radiation can be injected into the surface plasmon-polariton mode or modes of the multilayer structure by well-established means, for example by the use of a focusing system that may be combined with a prism in contact with the sample, that allows the necessary wave vector conservation in the direction parallel to the layers. Other means for coupling input optical radiation are by the use of a periodic grating on the multilayer structure or by the use of the end-fire technique of optical radiation incident on a side of the multilayer structure. For the multilayer structures that are isotropic in the direction parallel to the layers, that provide the greatest ease of fabrication, the required incident polarization of the optical radiation is p-polarized. This can be achieved by suitable alignment of the source of optical radiation, if linearly polarized, or by the use of polarizing elements. It is often not possible to couple directly to surface plasmon-polariton modes by direct incidence of optical radiation on the top or the bottom faces of the multilayer structure because of wave vector conservation in the direction parallel to the layers.

It is also possible to include electrical coupling into a subset of the surface plasmon-polariton modes. This configuration is particularly useful in the case of the device being used as an optical amplifier or an optical modulator, in which case the electrical coupling can control the amplification or modulation of the output optical radiation. Application to optical frequency conversion is also possible when using electrical coupling. One particular application of electrical coupling is to use it to produce surface-plasmon polaritons at angular frequency ω₀+δ in conjunction with input optical radiation at angular frequency ω₀. This configuration can be used to modulate optical output radiation at angular frequency ω₀+δ, for example. One means to achieve electrical coupling is to pass an electric current through one or more of the layers of the multilayer structure.

The number of incident beams of input optical radiation can be chosen for the particular application. In the case of no electrical coupling, if one incident beam is used, the device can be used as one for optical frequency conversion. In the case of no electrical coupling and when two, three or more incident beams are used, the device can be used in addition as an optical amplifier or as an optical modulator for frequency, amplitude, optical phase or state of polarization. Particular examples are the use of an incident beam of input optical radiation with central angular frequency ω₀ alone or in combination with an incident beam or beams of input optical radiation with central angular frequency ω₀+δ or ω₀−δ or both. The expression ‘central angular frequency’ here refers to the angular frequency at which the intensity of the optical radiation has its maximum value. This configuration can be used to produce modulated output optical radiation at central optical angular frequencies ω₀, ω₀+δor ω₀−δ or a combination of these, or used to produce amplified output optical radiation at central angular frequencies ω₀+δ or ω₀−δ or both. Another example is the use of two incident beams of input optical radiation with different central angular frequencies ωₐ and ω_{b}. This configuration can be used to produce modulated output optical radiation at central optical angular frequencies ωₐ, ω_{b}, ωₐ+δ or ω_{b}−δ or a combination of these, or used to produce amplified output optical radiation at central angular frequencies ωₐ+δ or ω_{b}−δ or both.

The frequency-converted output optical radiation can be coupled out of the multilayer structure by similar means, including the option of using the same element as that used to inject the optical radiation in.

The functionality of the device can be enhanced by allowing the angle of incidence or angular divergence of the incident beam of input optical radiation to be varied. In addition the sample can be fabricated in the form of a wedge, in which case the individual layers of the multilayer will not be parallel. One or more of them will in this case also be in the form of a wedge. These variations facilitate the tuning of the angular frequency of the frequency-converted output optical radiation.

A plurality of incident beams of input optical radiation can be used, not necessarily incident in the same plane of incidence or at the same spot on the multilayer structure. It is also possible to use the device at a plurality of optical frequencies by using more than one incident beam of input optical radiation or a single beam of input optical radiation with a plurality of optical frequency components.

The efficiency of the device can be enhanced by further confining the surface plasmon-polaritons or the optical radiation in a waveguide with an axis oriented parallel to the layers of the multilayer structure and bounded by two surfaces perpendicular to layers of the multilayer structure. This axis can be a straight or a curved line.

The efficiency of the device can also be enhanced by the incorporation of reflectors into the structure for the optical radiation or for the surface plasmon-polaritons. A possible configuration is to place two reflectors facing each other in a direction perpendicular to the layers, or to place reflectors either side of the structure in a direction parallel to the layers. These reflectors may in general be plane or possess a radius of curvature.

There is also no restriction on the overall curvature of the multilayer structure, that may possess a radius of curvature or radii of curvature.

In some applications it may be advantageous to choose a multilayer structure that is not isotropic in the direction parallel to the layers, in order to increase the functionality of the device as regards the coupling of different polarizations of input optical radiation.

It is also possible to mount the device on a cooling system in order to prevent overheating in the case of high power applications.

### BRIEF DESCRIPTION OF THE DRAWINGS

FIG. 1 shows the shape of a typical surface plasmon-polariton dispersion relation ω(k) at a conventional semi-infinite metal surface.

FIG. 2 shows the shape of a typical exciton dispersion relation ω(k) in a conventional semiconductor.

FIG. 3 shows the shape of a typical exciton-polariton dispersion relation ω(k) in a conventional semiconductor microcavity.

FIG. 4 shows a typical multilayer structure composed of parallel layers according to the present invention.

FIG. 5 shows the multilayer used in a first embodiment of the present invention.

FIG. 6 shows the calculated electromagnetic field distributions H_{y} and Eₓ plotted as a function of position z at an angular frequency far below two-dimensional surface plasmon-polariton angular frequency for the first embodiment of the present invention.

FIG. 7 shows the dispersion relation plotted as a function of k, calculated for the lowest energy surface plasmon-polariton mode of the multilayer structure of the first embodiment.

FIG. 8 shows the calculated decay length Lₓ plotted as a function of k on a linear-log scale for the lowest energy surface plasmon-polariton mode of the multilayer structure of the first embodiment.

FIG. 9 shows rough sketch of a close-up view of the dispersion relation ω(k) for the multilayer structure of the first embodiment.

FIG. 10 shows the calculated group velocity ν_{g}=dω/dk for the lowest energy surface plasmon-polariton mode of the multilayer structure of the present invention.

FIG. 11 shows plot of the allowed energy shift as a function of the energy at which two degenerate surface plasmon-polaritons can interact for the first embodiment.

FIG. 12 shows a first embodiment together with a particular means for coupling input optical radiation into the surface plasmon-polariton modes and a means for coupling output optical radiation out of the multilayer structure.

FIG. 13 shows rough sketch of a close-up view of the dispersion relation ω(k) for the multilayer structure of the first embodiment.

FIG. 14 shows a second embodiment of the present invention, suitable for application as a device for optical modulation or optical amplification.

FIG. 15 shows a third embodiment of the invention.

FIG. 16 shows a practical example of a multilayer structure realisable with readily available materials and that can be supported on a substrate.

FIG. 17 shows plot of the calculated allowed energy shift as a function of the energy at which two degenerate surface plasmon-polaritons can interact for the multilayer structure of FIG. 16.

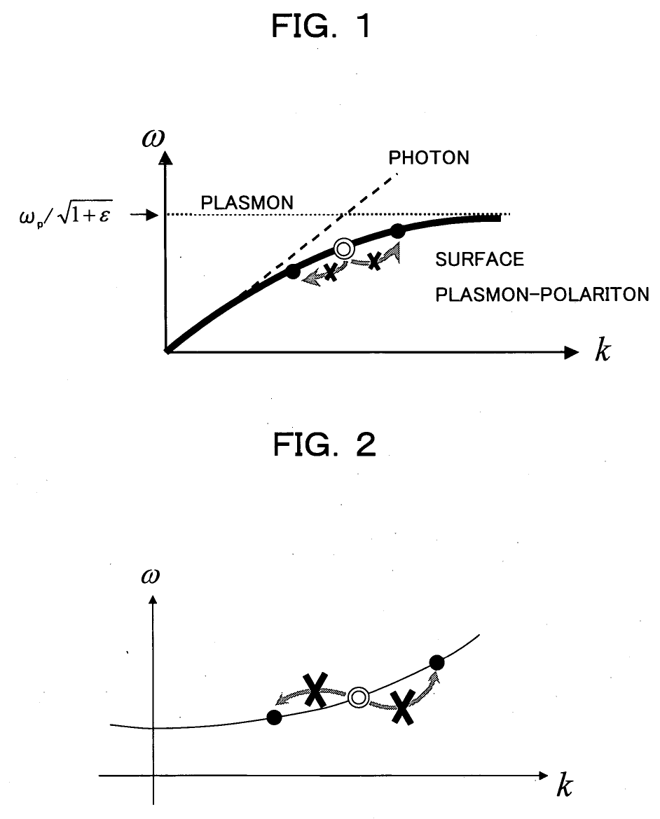

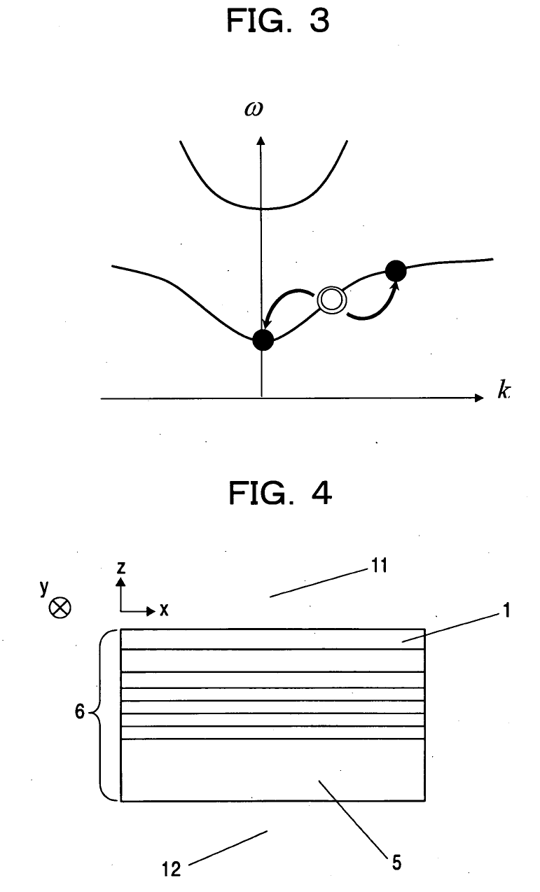

### BEST MODE FOR CARRYING OUT THE INVENTION

First we show that by judicious design of a multilayer structure it is possible to produce dispersion relations for the surface plasmon-polaritons that are optimised for optical parametric interactions. The process we consider is the interaction between two degenerate surface plasmon-polaritons which scatter and convert to higher and lower angular frequencies conserving energy and wave vector. Because of the boson statistics of surface plasmon-polaritons, this process is enhanced by an amount approximately proportional to the occupation of the final states of the interaction of the surface plasmon-polaritons, hence the nonlinearity can be extremely strong.

We demonstrate that it is possible to modify the dispersion relation of surface plasmon-polaritons by building tailored multilayer structures. Essentially we make use of a negative-dielectric constant-layer or layers, such as a metal, to pin the electric fields and impose an exponential decay whose penetration produces an effective dielectric constant dependent on wavelength. On the new dispersion relation the interaction of two degenerate surface plasmon-polaritons is allowed, allowing a resonant nonlinearity to build up over sub-millimetre or millimetre length scales.

The calculation of the surface plasmon-polariton modes in a multilayer system made up of planar layers with parallel interfaces can be achieved with the well known scattering matrix formalism for treating Maxwell's equations, applying the standard boundary conditions at the boundaries between each layer, and subsequently imposing the requirement for a decaying electromagnetic wave in the outermost two media of the multilayer structure. We work with the coordinate system in FIG. 4.

FIG. 4 shows a typical multilayer structure composed of parallel layers according to the present invention. The x direction is defined to be parallel to the layers of the multilayer in the same direction as the wave vector k of the surface plasmon-polariton mode in question. The y direction is defined to be parallel to the layers and perpendicular to the x direction. The z direction is directed perpendicular to the layers, and is directed towards the top of the multilayer structure. FIG. 4 also shows a typical multilayer structure 6 composed of parallel layers that may be made up of transparent, opaque or partially transparent layers for the angular frequency or frequencies of the optical radiation considered. In this example the bottom layer 5 of the multilayer structure 6 is thicker than the other layers, and can be considered as a substrate. The bottom layer 5 does not, however, in general need necessarily to be thicker than the other layers. In addition, there is a top medium 11 above the multilayer structure in contact with the top layer 1 and bottom medium 12 below the multilayer structure and in contact with the bottom layer 5. These media may be in general a gas, liquid or solid, but often will be air. The media 11 and 12 need not necessarily be the same media. There may also be different media in general at the sides of the multilayer that, for example, may aid in the case of the end-fire technique of optical radiation incident on a side of the multilayer structure. However, in most cases we may approximate the calculation of the surface plasmon-polariton modes by assuming that the extent of the multilayer structure 6 is infinite in the x and z directions. The magnetic field in the y direction is defined as H_{y}. The media 11 and 12 and the layers of the multilayer structure 6 are labelled consecutively with the label i. The field H_{y}⁽ⁱ⁾ corresponding to label i can be written as
H_{y}⁽ⁱ⁾=[cᵢexp(sᵢz)+dᵢexp(−sᵢz]exp[j(ωt−βx)]. (3)

Applying the electromagnetic boundary conditions for the continuity of H_{y} and the electric field Eₓ in the x direction at each interface parallel to x direction, we may find a transfer matrix corresponding to label i that we term Uᵢ defined by hᵢ=Uᵢhᵢ₋₁, where hᵢ=(cᵢ,dᵢ)^{T} and T means the transpose of the matrix. In equation (3) j=\sqrt{−1} and ω is the angular frequency. Both the propagating surface plasmon-polariton complex wave vector β in the x direction and the decay constant sᵢ=\sqrt{β₂−εᵢk₀²} in the z direction are in general complex quantities, where k₀ is the free space wave vector, εᵢ=εᵢ′−jεᵢ″ is the complex dielectric constant corresponding to label i, and k is the real part of β. Across an entire multilayer structure of N material layers one finds a total transfer matrix

$$V = {\sum }_{i = 1}^{N} {U}_{i}$$

that can be straightforwardly converted into a scattering matrix, S, that is known to be stable for multilayer solutions, as explained for example by S. G. Tikhodeev et al. in Physical Review B 66, 45102-1-17, 2002. This matrix defines the exponentially increasing waves produced when exponentially decaying waves are fed into the multilayer from either side:

$$( \begin{matrix}{c}_{N} \\ {d}_{0}\end{matrix} ) = S ( \begin{matrix}{c}_{0} \\ {d}_{N}\end{matrix} ) = ( \begin{matrix}0 \\ 0\end{matrix} )$$

By setting the result to zero as in this equation, only bound solutions for surface plasmon-polaritons propagating in the x direction are allowed. Stable solutions thus require that det(S)=0, where det means taking the determinant. This allows the values of the complex wave vector β to be found that represent guided surface plasmon-polariton modes at each angular frequency ω. For each guided surface plasmon-polariton mode found, the corresponding electromagnetic field distribution can be recovered from the equation

$${E}_{x}^{( i )} = \frac{1}{ω {ɛ}_{0} {ɛ}_{i}} ( j \frac{\partial {H}_{y}^{( i )}}{\partial z} , 0 , - β {H}_{y}^{( i )} ) ,$$

where ε₀ is the permittivity of free space and Eₓ⁽ⁱ⁾ corresponds to label i. It is also straightforward to calculate the electric field in the z direction from Maxwell's equations.

At each surface plasmon-polariton mode angular frequency ω it is in general possible to find a number of solutions. However, the lowest energy mode usually corresponds to a long-range surface plasmon-polariton mode. This long-range surface plasmon-polariton mode for typical metals has a propagation length of sub-millimetre to millimetre order and is the one of particular interest for the present invention. Other modes are, however, not excluded from use in the present invention. Long range surface plasmon-polariton modes are well known to those skilled in the art, and are discussed, for example, by F. Yang et al. in Physical Review B 44, 5855-5872, 1991 and by J. J. Burke at al. in Physical Review B 33, 5186-5200, 1986.

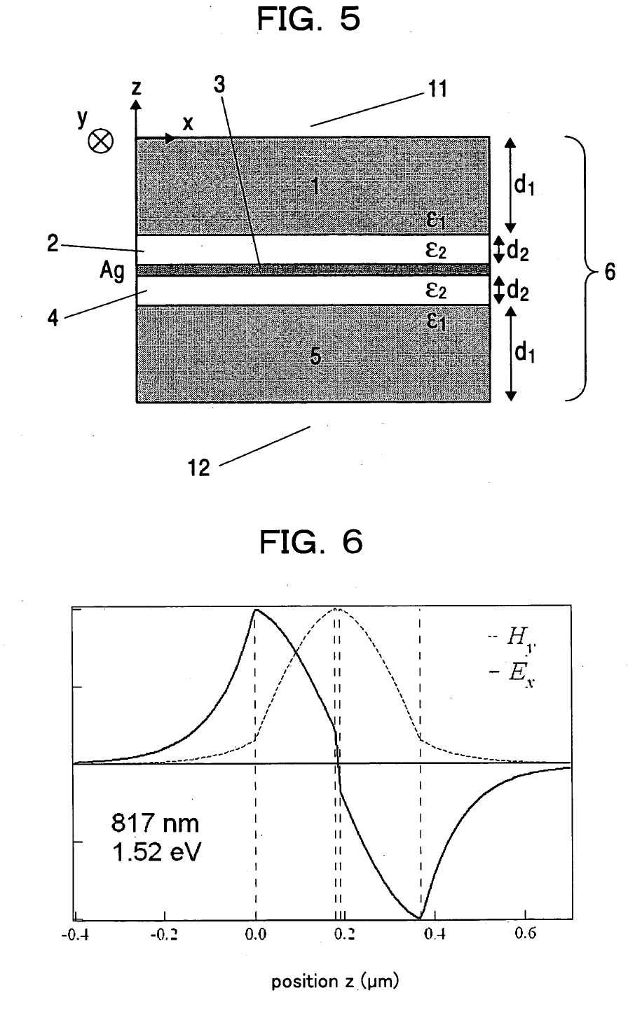

FIG. 5 shows the multilayer used in a first embodiment of the present invention, a multilayer structure 6 made with five planar parallel layers in order 1-5 from the top of the structure, consisting of four transparent layers 1, 2, 4, 5 that play the role of other layers with a positive dielectric constant placed in a symmetric configuration two either side of a layer 3 that plays the role of a layer with a negative dielectric constant. The means for electrical coupling is absent in this embodiment. We shall later describe the means for coupling input optical radiation into the surface plasmon-polariton modes or the means for coupling output optical radiation out of the multilayer structure for this first embodiment. Such means is required for the operation of the device but is omitted in FIG. 5 for clarity. For this first embodiment we have assumed that the dielectric constants of the transparent dielectric layers 1 and 5 are ε₁=1.0, for example approximately corresponding to a medium such as air, and the dielectric constants of the layers 2 and 4 are ε₂=4.0. Later we shall present another example of a device in which ε₁ is not equal to 1. In addition the thickness d₂=180 nm of layer 2 is assumed to be the same as layer 4, and the thickness d₁ of layer 1 is assumed to be the same as layer 4, with the additional assumption d₁>>d₂. The layer 3 is assumed to be composed of silver with a thickness of 10 nm, with a complex dielectric constant that varies with optical wavelength according to typical literature data.

FIG. 6 shows the calculated electromagnetic field distributions H_{y} (shown as the curved dashed line) and Eₓ (shown as the solid line) plotted as a function of position z at an angular frequency for an angular frequency close to the two-dimensional surface plasmon-polariton angular frequency ωₚ/\sqrt{1+ε₂} for the first embodiment of the present invention. The calculation applies to the lowest energy surface plasmon-polariton mode of the multilayer structure 6. The vertical dashed lines mark the interfaces.

The wavelength of the surface plasmon-polariton mode used in FIG. 6 is 817 nm, which is corresponding to an energy of 1.52 eV. The electric field is asymmetric about the negative dielectric layer in the surface plasmon-polariton mode, which is not applied only to FIG. 6. This serves to reduce the overlap of the mode with the lossy metal, hence increasing the decay length Lₓ in the x direction:

$${L}_{x} = \frac{1}{2 Im ( β )} ,$$

where Im means taking the imaginary part. Although the decay of the electric field Eₓ in the outer dielectric layers is similar at all angular frequencies, the inner higher-dielectric-constant layers 2 and 4 surrounding the metal layer 3 elicit strong modulation of the electric field penetration at different angular frequencies. This enables us to tailor the dispersion relation of the surface plasmon-polaritons. The possibility of the interaction of two degenerate surface plasmon-polaritons is achieved in general through the third-order nonlinear optical properties of the metal or the dielectric layers. Moreover, the negative dielectric constant layer 3 serves to pin and confine the electromagnetic fields in position inside the multilayer structure and to thus enhance the efficiency of the optical parametric interaction.

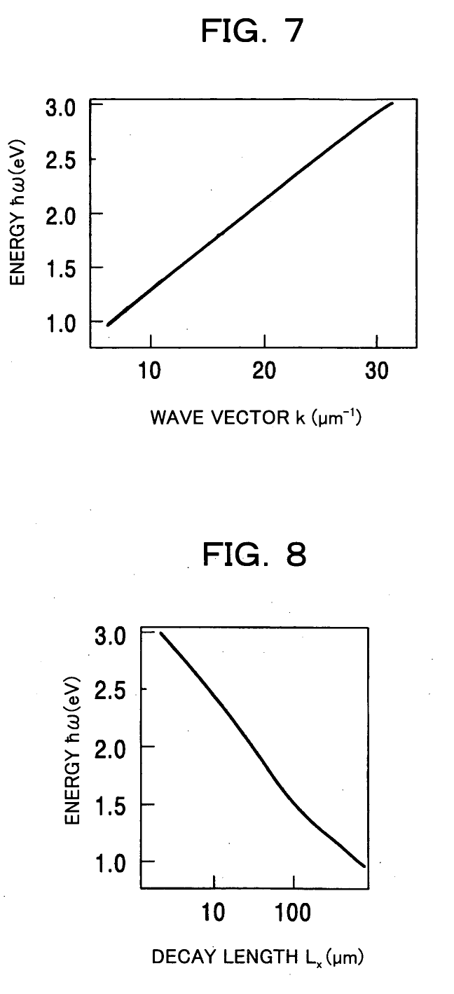

The dispersion relation calculated for the lowest energy surface plasmon-polariton mode of the multilayer structure 6 of this first embodiment is shown in FIG. 7. The calculated decay length Lₓ is plotted as a function of kin FIG. 8 on a linear-log scale.

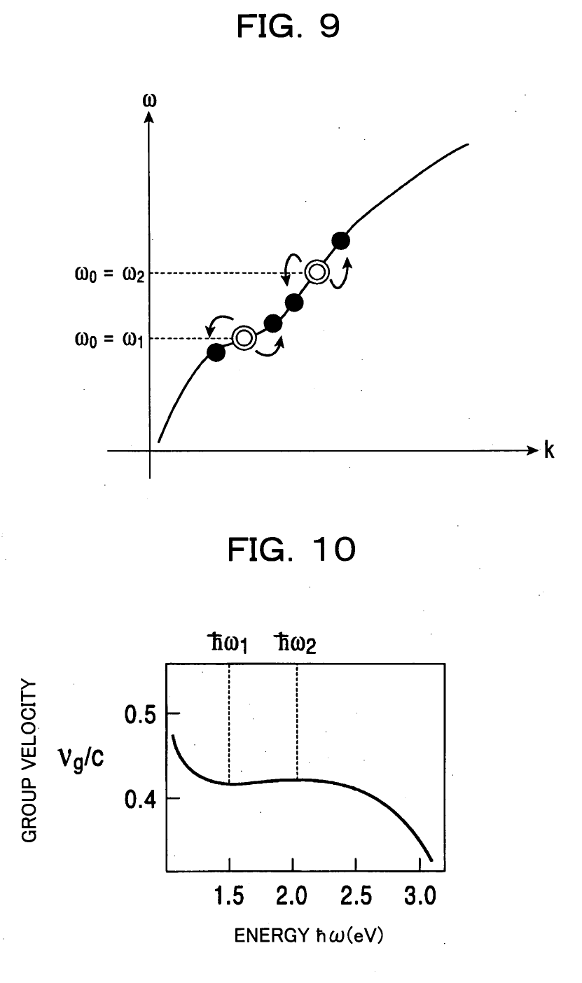

The decay length for an energy of 1.5 eV corresponding to the visible optical range is approximately equal to 100 μm, sufficient for an effective nonlinear interaction process. One condition for a multilayer structure to satisfy equations (1) and (2) is that the surface plasmon-polariton dispersion relation ω(k) has at least one point of inflection at some wave vector. The plot of FIG. 9 shows rough sketch of a close-up view of the dispersion relation ω(k) of FIG. 8 for the multilayer structure 6, exaggerated to show more clearly that there are in fact two points of inflection. We define ω₁ and ω₂ to correspond to the lower and upper values of angular frequencies ω corresponding to these two points of inflection, respectively. Also sketched in FIG. 9 are the transitions for surface plasmon-polaritons that are allowed according to equations (1) and (2) at these two angular frequencies for the particular case ωₐ−ω_{b}. The open circles represent the starting points for the transitions and the closed circles represent the finishing points.

In FIG. 10, the calculated group velocity for the multilayer structure 6, denoted by the symbol ν_{g} wherein ν_{g}=dω/dk, is plotted in units of c as a function of surface plasmon-polariton energy [symbol] ω, where c is the velocity of light in free space. The energies [symbol] ω₁ and [symbol] ω₂ are also shown on this plot. These two surface plasmon-polariton energies correspond to the turning points on this plot.

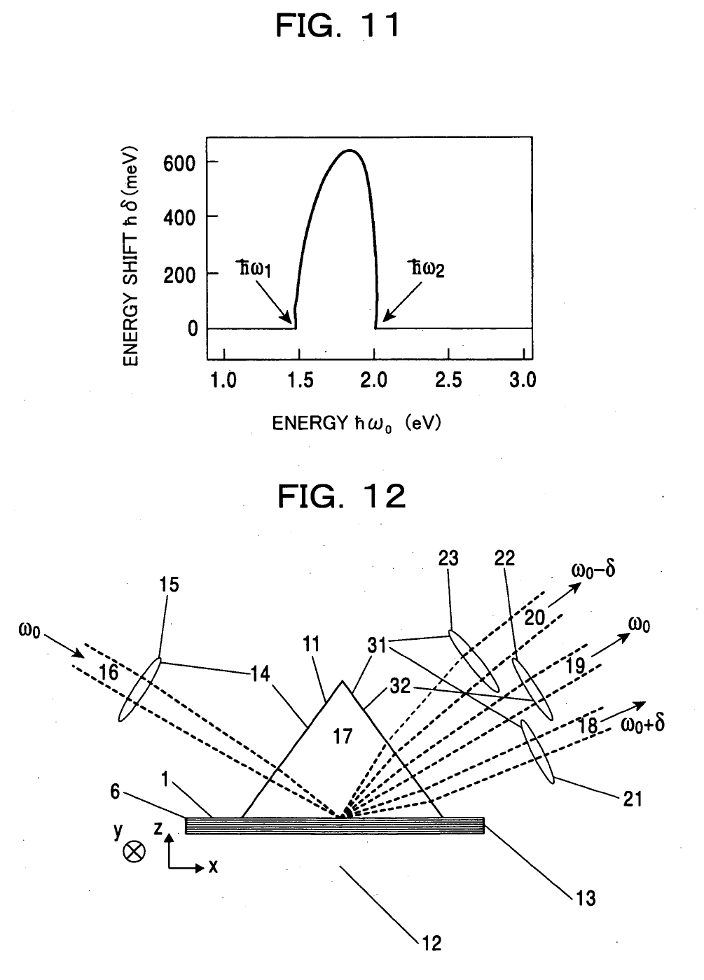

FIG. 11 shows plot of the allowed energy shift as a function of the energy at which two degenerate surface plasmon-polaritons can interact for the first embodiment.

For angular frequencies between ω₁ and ω₂ or in the region near ω₁ or ω₂ for this first embodiment it is possible to find a range of possible values for the particular angular frequency shift δ in equations (1) and (2) for the particular case ωₐ=ω_{b}=ω₀ and to construct a plot of the possible values of [symbol] δ representing all such allowed parametric interaction processes for this case: a plot of the allowed energy shift [symbol] δ as a function of the energy [symbol] ω₀ at which two degenerate surface plasmon-polaritons interact is shown in FIG. 11. This plot is crucial to the functioning of the device. One can see that for this first embodiment the energy shift [symbol] δ has a maximum value of approximately 630 meV for [symbol] ω0 equal to 1.8 eV, corresponding to an optical wavelength 690 nm. The wavelength shifts corresponding to this value of [symbol] δ=630 meV are a wavelength shift of 180 nm and 370 nm, the output optical radiation of 510 nm and 1.06 μm can be obtained, respectively. It is also of practical interest that for some angular frequencies ω₀ near ω₁ and ω₂ it is possible to have two different values for the energy shift [symbol] δ.

This allows the simultaneous presence of four different angular frequencies in the output optical radiation in this case of ωₐ=ω_{b}=ω₀, in addition to the unconverted output optical radiation at angular frequency ω₀. By selecting the central angular frequency or the angular frequency spectrum of the incident beam of input optical radiation in this embodiment it is possible to vary the angular frequencies of the output optical radiation, thus realising a device with a tunable optical frequency.

By optimizing the parameters of the particular five-layer multilayer structure 6 considered in this first embodiment, ε₁ ε₂, d₁, d₂ and the metal thickness or type of metal, we can modify the dispersion relation and hence the particular properties of the parametric interaction. The maximum allowed bandwidth for the frequency-converted output optical radiation and the angular frequency of the input optical radiation that produces it are governed by the dielectric constant ratio ε₁:ε₂, the actual values of ε₁ and ε₂ and the thickness of the high dielectric constant layer d₂ of layers 2 and 4. For example, with thin metal layers it is possible to create a device which allows a resonant parametric interaction with a very narrow band of angular frequencies for the input optical radiation to give a wide range of energy shifts δ. This is the ideal situation for producing broadband parametric optical amplification, for example for generating white light from an intense pulsed laser to give a supercontinuum.

With the parametric interaction allowed between surface plasmon-polaritons of energies [symbol] ωₐ= [symbol] ω_{b}= [symbol] ω₀ in FIG. 11, that gives a non-zero value of energy shift [symbol] δ, the interaction strength can be hugely enhanced. This can be seen by the analogy with the case for exciton-polaritons in semiconductor microcavities because of the boson statistics of surface plasmon-polaritons. The same conclusions apply to the more general case with [symbol] ₐ≠ [symbol] ω_{b}. For these reasons the device is therefore ideally suited for applications for high efficiency optical modulation, optical amplification or optical frequency conversion.

The incident beam or beams of input optical radiation can advantageously be chosen as being derived from a laser source that can be composed of a pulse or pulses of coherent radiation with a well-defined central angular frequency. For example, a periodic train of optical pulses from a mode-locked laser can be used. Examples of lasers that can be used are gas, solid-state or semiconductor lasers. The use of a pulsed laser is advantageous because of the high peak-power attainable, resulting in higher optical parametric conversion efficiencies for a given average power of the incident beam of input optical radiation. It is however also possible to make use of continuous wave laser radiation with a well-defined central angular frequency for the incident beam or beams of input optical radiation. It is possible and sometimes advantageous to make use of more than one laser source to allow a wider range of input angular frequencies for the incident optical radiation. A combination of pulsed coherent laser radiation and continuous wave laser radiation may also be used. It is also possible to make use of laser pulses or continuous wave radiation with a more complex angular frequency spectrum in which there is no well-defined central angular frequency.

FIG. 12 is the first embodiment together with a particular means for coupling input optical radiation into the surface plasmon-polariton modes and a means for coupling output optical radiation out of the multilayer structure.

FIG. 12 shows the first embodiment together with a particular means 14 for coupling input optical radiation into the surface plasmon-polariton modes and a means for coupling output optical radiation out of the multilayer structure. These particular means are suited for application as a device for optical frequency conversion. An important consideration is the choice of the means 14 for coupling input optical radiation into the surface plasmon-polariton modes. Such means are well-known to those skilled in the art. To obtain a sufficient optical intensity of the input optical radiation at the multilayer structure 6 it is advantageous to use some type of focusing system 15, such as a lens or mirror system, for the incident beam of input optical radiation 16 as shown in FIG. 12 in which the incident beam 16 is incident in the x-z plane. In this first embodiment, only one incident beam of input optical radiation 16 is used. The central angular frequency of the beam 16 is chosen to be an angular frequency ωₐ=ω_{b}=ω₀, for which a finite angular frequency shift δ or set of shifts can be obtained.

In order to couple the input optical radiation into the surface plasmon-polariton modes one may make use of coupling through a dielectric material 17 that is placed in contact with, for example, the top layer 1 of the multilayer structure 6. This dielectric material 17 in FIG. 12 plays the role of the top medium 11 in the determination of the surface plasmon-polariton modes. As is known to those skilled in the art, in general one uses such a dielectric material 17 with a higher dielectric constant than the top layer 1 of the multilayer structure 6. Typical forms for such dielectric materials 17 are prisms, hemispheres or hemicylinders, although other forms are possible. In this first embodiment the dielectric material 17 is in the form of a prism. It is also possible to place a second dielectric material between the dielectric material 17 and a surface of the multilayer structure. It is also possible to couple input optical radiation into the surface plasmon-polariton modes from of the bottom side of the multilayer structure 6.

As is known to those skilled in the art the angle of incidence of the incident optical radiation is critical for coupling input optical radiation into a surface plasmon-polariton mode because of the requirement for matching the wave vector of the incident light and the wave vector of the surface plasmon-polariton in the x direction. In addition, the range of incident angles of the input optical radiation that can be coupled will depend on the damping of the surface plasmon-polariton mode. The choice of the angular divergence of the incident beam of input optical radiation 16 is therefore important. The focusing system 15 and the parameters of the incident beam of input optical radiation 16, for example the beam width, determine the angular divergence of the beam 16 in the region of the multilayer structure 6. By varying the angle of incidence and the angular divergence the characteristics of the output optical radiation can therefore be varied. For multilayer structures 6 that are isotropic in the direction parallel to the layers it is advantageous to make use of linearly polarized input optical radiation polarized in the plane of incidence. This can be achieved using means for coupling input optical radiation into surface plasmon-polariton modes including polarizing elements such as linear polarizers, or by choice of an optical source for the incident beam of input optical radiation 16 that is linearly polarized.

As is known to those skilled in the art an alternative means 14 for coupling input optical radiation into the surface plasmon-polariton modes is the end-fire technique of coupling the incident beam of input optical radiation 16 into a side 12 of the multilayer structure 6. Another means 14 is to make use of a periodic grating structure on the surface of or inside the multilayer structure 6.

Another important consideration is the choice of the means for coupling output optical radiation out of the multilayer structure 6. In this first embodiment optical radiation is coupled out of the multilayer structure by the same dielectric material 17 as was used for coupling input optical radiation into the surface plasmon-polariton modes. In this configuration, because of the requirements of wave vector matching in the x direction, frequency-converted output optical radiation with different angular frequencies exits the dielectric material 17, in the form of a prism in this example, at different angles. In this embodiment separate focusing systems 22, 21 and 23, in the form of lenses, are used as part of the means for coupling the output optical radiation 19, 18 and 20 of angular frequencies ω₀, ω₀+δ and ω₀−δ respectively, out of the multilayer structure 6. These focusing systems serve to collimate the output optical radiation. The separate focusing systems 22, 21 and 23 can if required by replaced by a single focusing system. Or, alternatively, one or more of the focusing systems 21-23 may not be required at all. Together the dielectric material 17 and the focusing system 22 comprise the means 32 for coupling output optical radiation at any angular frequency out of the multilayer structure. Together the dielectric material 17 and the focusing systems 21 and 23 comprise the means 31 for coupling output optical radiation at angular frequencies ωₐ+δ or ω_{b}−δ out of the multilayer structure, where in this case of the first embodiment ωₐ=ω_{b}=ω₀. As is known to those skilled in the art, and as was the case when considering the coupling of the input optical radiation into the surface plasmon-polariton modes, one may use such a dielectric material 17 with a higher dielectric constant than the top layer 1 of the multilayer structure 6 for coupling output optical radiation out of the multilayer structure. Typical forms for such dielectric materials 17 are prisms, hemispheres or hemicylinders, although other forms are possible. It is also possible to place a second dielectric material between the dielectric material 17 and a surface of the multilayer structure 6, for example an index matching liquid. It is also possible to couple optical radiation out of the bottom side of the multilayer structure 6 while coupling optical radiation in from the top side, and vice versa.

Other angular frequencies of radiation, for example those such as 2ω₀ generated by second order nonlinear effects, may be coupled out by, for example, the addition of extra focusing systems if required, thus making up means for coupling output optical radiation at angular frequencies other than ωₐ, ω_{b}, ωₐ+δ or ω_{b}−δ out of the multilayer structure. These are not shown in FIG. 12 and are usually not required. The efficiency of the third order optical parametric process of concern here is in general much larger than that of such second order effects. It is also possible to make use of the end-fire technique or of grating techniques for coupling output optical radiation out of the multilayer structure 6. If it is required to restrict the angular frequencies of the output optical radiation an optical frequency filtering system using, for example, dichroic mirrors, can be used to select particular angular frequencies of output optical radiation. In particular this can be advantageous when using the end-fire technique for coupling output optical radiation out of the multilayer structure 6 when the output optical radiation at different angular frequencies exits in the same direction.

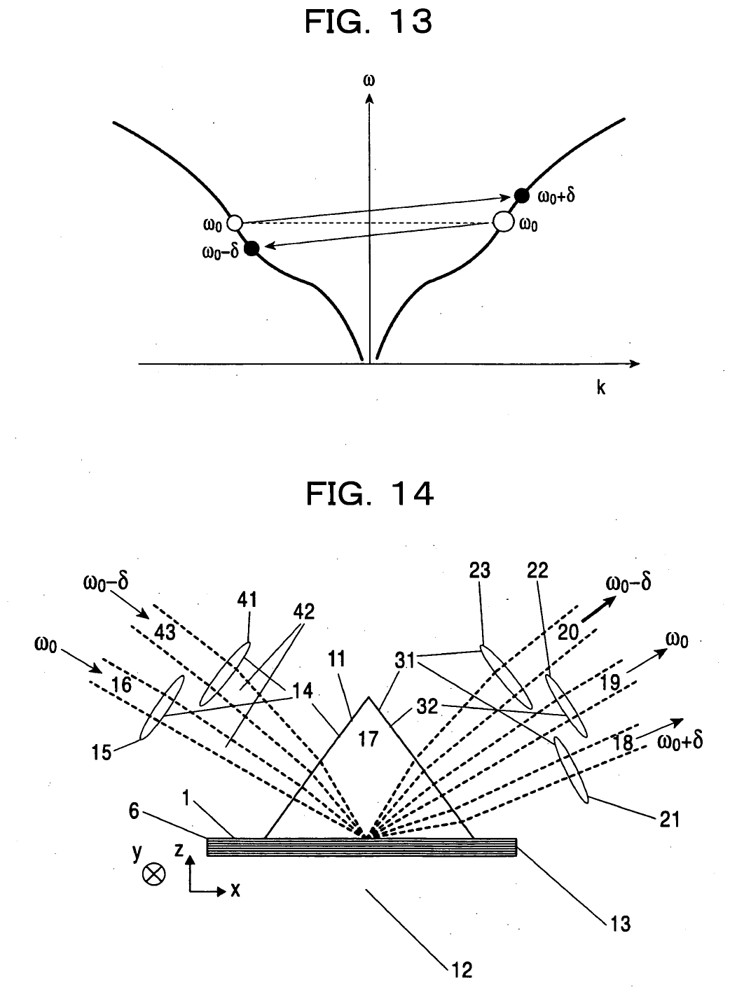

This first embodiment is suited for application as a device for optical frequency conversion by means of a single incident beam of input optical radiation 16. Variations on the above embodiment are possible. In general it is possible to use more than one incident beam of input optical radiation 16, for example with angular frequencies ωₐ≠ω_{b}, in which case the two beams of output optical radiation corresponding to 18 and 20 have angular frequencies ωₐ+δ and ω_{b}−δ, respectively. The incident beams of input optical radiation may, for example, be coupled to surface plasmon-polariton modes with oppositely directed wave vectors, to exploit the type of interaction shown in FIG. 13.

FIG. 13 shows rough sketch of a close-up view of the dispersion relation ω(k) for the multilayer structure 6 of the first embodiment. Positive and negative values of k are included in this figure. The calculation applies to the lowest energy surface plasmon-polariton mode of the multilayer structure 6. In a variation on the first embodiment, also sketched is a transition corresponding to the optical parametric interaction of two surface plasmon-polaritons that is allowed according to the conservation of surface plasmon-polariton energy and wave vector. The open circles represent the starting points for the transitions and the closed circles represent the finishing points. In this example, the direction of the wave vector of the surface plasmon-polaritons changes direction when undergoing a transition.

In this variation of the first embodiment the two surface plasmon-polaritons of angular frequency ω₀ have oppositely directed wave vectors, and arise from two beams of input optical radiation with the same angular frequency ω₀. These two surface plasmon-polaritons are converted to surface plasmon-polaritons of angular frequencies ω₀+δ and ω₀−δ also with oppositely directed wavevectors, and result in output optical radiation with angular frequencies ω₀+δ and ω₀−δ, respectively. The transitions shown as an example in FIG. 13 correspond to the optical parametric interaction of two surface plasmon-polaritons of angular frequency ω₀≈ω₂. In the general case, beams having different planes of incidence may be used simultaneously. In addition, different beams may be focused to more than one point on the multilayer 6 at the same or different angles of incidence. The different beams may also have different central angular frequencies. This may be useful, for example, in the case in which the multilayer structure is not homogeneous in the direction parallel to the layers, as in a wedge.

The second embodiment of the invention shown in FIG. 14 is suitable for application as a device for optical modulation or optical amplification. The means for electrical coupling is absent in this embodiment. In this embodiment, two incident beams of input optical radiation 42 are used, made up of an incident beam 16 and an incident beam 43, both in the same plane of incidence. The central angular frequency of the beam 16 is chosen to be an angular frequency ωₐ=ω_{b}=ω₀ for which a finite angular frequency shift δ or set of shifts can be obtained. The central angular frequency of the beam 43 is chosen to be the angular frequency ω₀−δ or one of the angular frequencies ω₀−δ. We show a particular means 14 for coupling input optical radiation into the surface plasmon-polariton modes and a means for coupling output optical radiation out of the multilayer structure. The means 14 for coupling input optical radiation into the surface plasmon-polariton modes consists of a focusing system 15 for the beam 16 and a focusing system 41 for the beam 43. Both beams 16 and 43 are incident in the x-z plane. In order to couple the input optical radiation into the surface plasmon-polariton modes, coupling through a dielectric material 17 placed in contact with the top layer 1 of the multilayer structure 6 is used. As with the first embodiment, this dielectric material 17 is in the form of a prism. Because of the requirement for matching the wave vector of the incident light and the wave vector of the surface plasmon-polaritons in the x direction, the angle of incidence for the incident beams 16 and 43 are different. For this reason two different focusing systems 15 and 41 are chosen, although it is possible to use a single focusing system for both beams if required.

The means for coupling output optical radiation out of the multilayer structure 6 are the same as for the first embodiment. The boson statistics of the surface plasmon-polaritons implies that the optical parametric interaction process for amplification at angular frequency ω₀−δ is enhanced by an amount approximately proportional to the product of (i) the occupation of the final state of the interaction of the surface plasmon-polaritons and (ii) the occupation of the initial state of the surface plasmon-polaritons. Injecting input optical radiation into surface plasmon-polariton modes at frequency ω₀−δ thus allows the efficiency of the conversion process from ω₀ to ω₀−δ to be greatly enhanced, and can lead to a huge amplification of the incident beam of input optical radiation 43 at angular frequency ω₀−δ to produce an intense output optical radiation 20 at angular frequency ω₀−δ with a net optical gain with respect to the incident beam of input optical radiation 43 at angular frequency ω₀−δ that is much greater than 1. This optical gain is essentially proportional to the product of the intensity of the input optical radiation at angular frequency ω₀ and the intensity of the input optical radiation at angular frequency ω₀−δ and so it is advantageous to choose intense input optical radiation at angular frequency ω₀.

It may also be useful to make use of the output optical radiation 18 at angular frequency ω₀+δ in this embodiment, although in this case it is not amplified.

This second embodiment has obvious applications as an optical modulator. By modulating the frequency, amplitude, optical phase or state of polarization of at least one frequency-component of the input optical radiation, it is possible to modulate the frequency, amplitude, optical phase or state of polarization of at least one frequency-component of the output optical radiation. A particular example of such an optical modulator is the use of an amplitude-modulated incident beam of input optical radiation 16 at angular frequency ω₀ to amplitude-modulate the output optical radiation 20 at angular frequency ω₀−δ. Other combinations of modulated input optical radiation and output optical radiation in this embodiment are also possible. As with the first embodiment many variations for coupling the output optical radiation out of the multilayer structure 6 are possible.

In an obvious variation on the second embodiment the incident beam of input optical radiation 43 at angular frequency ω₀−δ is replaced by an incident beam of input optical radiation 43 at angular frequency ω₀+δ. In this case it is the optical radiation at angular frequency ω₀+δ that is amplified.

It is also possible to generalize the second embodiment by using three incident beams of input optical radiation 42 incident in the same plane of incidence with central angular frequencies ω₀, ω₀−δ and ω₀+δ. In that case it is possible to simultaneously amplify optical radiation at angular frequencies ω₀−δ and ω₀+δ by means of intense input optical radiation at angular frequency ω₀.

It is also possible to generalize the second embodiment by using two incident beams of input optical radiation 42 with the same central angular frequency coo and use one of these beams to modulate the other.

It is also possible to generalize the second embodiment by using two incident beams of input optical radiation with different central angular frequencies ω_{b}−δ and ωₐ, for example, to produce output optical radiation at frequencies ω_{b}−δ, ωₐ+δ and ωₐ.

In general, to enhance the functionality of the device, a plurality of incident beams of input optical radiation 42 can be used, not necessarily incident in the same plane of incidence or at the same spot on the multilayer structure 6. It is also possible to use the device at a plurality of optical frequencies by using more than one incident beam of input optical radiation or a single beam of input optical radiation with a plurality of optical frequency components.

The same variations as regards means for coupling input optical radiation into the surface plasmon-polariton modes and means for coupling output optical radiation at angular frequencies ωₐ+δ or ω_{b}−δ out of the multilayer structure as discussed in the context of the first embodiment can be applied to the second embodiment and any other embodiment.

It is also possible to include means for electrical coupling into a subset of the surface plasmon-polariton modes. One particular application of electrical coupling is to use it to produce surface-plasmon polaritons at central angular frequency ω₀+δ in conjunction with input optical radiation at central angular frequency ω₀. This configuration can be used to modulate optical output radiation at central angular frequency ω₀+δ, for example, that can thus be greatly amplified compared to the input optical radiation at central angular frequency ω₀.

Other variations as regards the combination of the means for electrical coupling into a subset of the surface plasmon-polariton modes and the means for coupling input optical radiation into the surface plasmon-polariton modes are possible in direct analogy with the above discussions of the various ways of choosing optical angular frequencies and the number of optical beams. It is possible to provide electrical coupling into a plurality of surface plasmon-polariton modes in combination with a plurality of beams of input optical radiation in order to produce a plurality of beams of output optical radiation.

One means to achieve electrical coupling is to pass an electric current through one or more of the layers of the multilayer structure. This layer could be a metal layer to produce the surface-plasmon polaritons by direct resistive heating, for example. Another possibility is by electrical coupling into a subset of the surface plasmon-polariton modes by tunnelling of electrons through an insulating layer.

It is also possible to make a suitable multilayer structure that allows the optical parametric interaction of two degenerate surface plasmon-polaritons by choosing part of the multilayer structure to be composed of a sandwich made up of an odd number of materials greater or less than five, with one layer with a negative dielectric constant at the centre, and with other layers with a positive dielectric constant disposed symmetrically either side. However, it is also possible make suitable multilayer structures which do not possess such symmetry. Moreover, the multilayer structure can be composed of layers that are thin enough for the multilayer structure to be considered as a graded distribution of dielectric constant in the direction perpendicular to the layers.

In general the layers with a negative dielectric constant of the multilayer structure can also be composed of semiconductor or doped semiconductor, or other material such as an organic material, without restriction to metals. A mixture of different negative dielectric constant materials is also possible in a single multilayer structure. Likewise, the other layers with a positive dielectric constant can be chosen from any material provided that the imaginary part of the dielectric constant is sufficiently small. Some layers may happen to have zero dielectric constant at the angular frequencies ωₐ or ω_{b} or both.

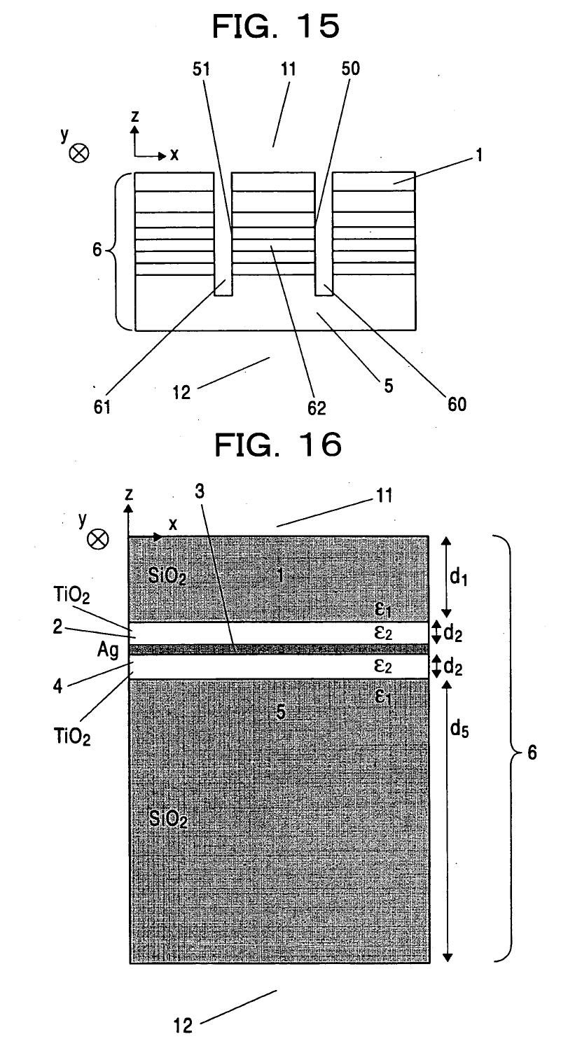

The efficiency of the device can be enhanced by the incorporation of reflectors into the structure for the optical radiation or for the surface plasmon-polaritons. A third embodiment of the invention is shown in FIG. 15, in which the multilayer structure 6 incorporates two planar reflectors 50 and 51 facing each other in a direction perpendicular to the layers. These two reflectors may be the untreated side faces of the multilayer structure 6 or may be coated to enhance their reflectance. These reflectors can be created by etching or otherwise forming two parallel trenches 60, and 61 in the multilayer structure with the axes of the trenches preferentially perpendicular to the plane of optical incidence. The separation of the trenches can be chosen judiciously either to cause multiple optical reflections or multiple surface plasmon-polariton reflections in the region of the multilayer structure 62 between the reflectors 50 and 51 and thus enhance the efficiency of the device. The means for coupling input optical radiation into the surface plasmon-polariton modes or the means for coupling output optical radiation out of the multilayer structure are not shown in FIG. 15 for clarity.

In an alternative embodiment, similar to the third embodiment, the reflectors may be curved in order to form, for example, a confocal cavity.

In an alternative embodiment, reflectors may be placed above and below the multilayer structure in order to further confine the electromagnetic fields and thus enhance the efficiency of the device. Such reflectors can consist of distributed Bragg reflectors or more generally can consist of one-dimensional photonic crystals with a photonic bandgap adjusted to help confine the electromagnetic fields in the negative dielectric constant layer or layers.

There is also no restriction on the overall curvature of the multilayer structure, that may possess a radius of curvature or radii of curvature. However, due account must be taken of this curvature when choosing the angle of incidence and angular divergence of the incident optical radiation for coupling input optical radiation into a surface plasmon-polariton mode. The curvature of the surface may, for example, have spherical or cylindrical symmetry. The use of cylindrical symmetry has the advantage of being compatible with optical fibre technology. The use of a sphere or a cylinder can allow the possibility of optical or plasmon resonances by propagation around the sphere or cylinder, and consequent enhancement of the device efficiency, when the dimensions of the sphere or cylinder are sufficiently small compared to the relevant optical absorption length or the plasmon decay length Lₓ.

In addition the sample can be fabricated in the form of a wedge, in which case the individual layers of the multilayer will not be parallel, one or more of them being also in the form of a wedge. This facilitates the tuning of the angular frequency of the frequency-converted output optical radiation by varying the position on the wedge on which the input optical radiation is incident.

It is also possible to combine the concept of a wedge with a multilayer structure that possesses a radius of curvature or radii of curvature. One example of this is the use of a multilayer structure in the form of a tapered cylinder or on the surface of a sphere.

The efficiency of the device can be enhanced by further confining the surface plasmon-polaritons or the optical radiation in a waveguide with an axis oriented parallel to the layers of the multilayer structure and bounded by two surfaces perpendicular to the layers of the multilayer structure. An example of such a waveguide is what is known to those skilled in the art as a rib waveguide that can provide confinement effectively in one dimension, and moreover is convenient for the case of input optical radiation incident on a side of the multilayer structure or output optical radiation exiting from a side of the multilayer structure. The axis of this waveguide may also be curved, and even closed in a ring to serve as a resonator in a way similar to that described for a sphere and a cylinder above.

In some applications it may be advantageous to choose a multilayer structure that is not isotropic in the direction parallel to the layers or in the direction perpendicular to the layers in order to increase the functionality of the device as regards the coupling of different polarizations of input optical radiation.

It is also possible to mount the device on a cooling system in order to prevent overheating and possible damage of the device in the case of high power applications. There is, in general, no problem with the use of room temperature or ambient temperatures as the operating temperature for devices based on surface-plasmon polaritons, facilitating the implementation of the present invention.

### EXAMPLES

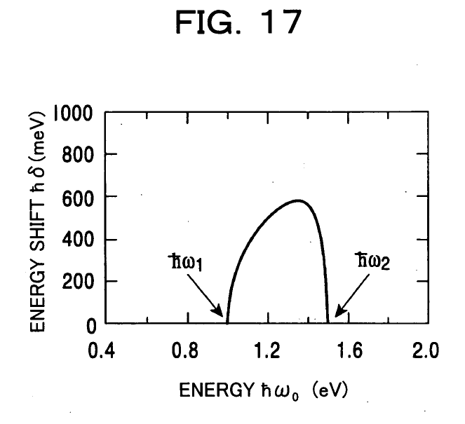

FIG. 16 shows a practical example of a multilayer structure 6 realisable with readily available materials and that can be supported on a substrate. The multilayer structure 6 is a five-layer structure made up of five planar parallel layers in the order 1-5 from the top of the structure, consisting of four transparent layers 1, 2, 4, 5 that play the role of the other layers with a positive dielectric constant placed in a symmetric configuration two either side of a silver layer 3 that plays the role of a layer with a negative dielectric constant. The dielectric layers 1 and 5 are vitreous silica with a frequency-dependent dielectric constant approximately equal to 2.2 in the optical region. The bottom layer 5 can also serve as a substrate to support the device. The dielectric layers 2 and 4 are titanium dioxide with a frequency-dependent dielectric constant approximately equal to 5.8 in the optical region. The thickness of layers 2 and 4 is d₂=210 nm, and the thickness d₁ of layer 1 and d₅ of layer 5 are chosen so that d₁>>d₂ and d₁>>d₅. The layer 3 with a negative dielectric constant is assumed to be composed of a silver layer of thickness 10 nm. The dielectric constants of these three materials, vitreous silica, titanium dioxide and silver, as a function of optical wavelength are known from typical literature data, and these variations are used in the calculations.

Because the bottom layer 5 is made of a solid such as vitreous silica, rather than a material with a dielectric constant equal to 1, it can be used to support the multilayer structure 6.

FIG. 17 shows the calculated plot of the possible values of [symbol] δ representing all allowed parametric interaction processes as a function of the energy [symbol] ωₐ= [symbol] ω_{b}= [symbol] ω₀ at which two degenerate surface plasmon-polaritons interact for the multilayer structure of FIG. 16. The calculation applies to the lowest energy surface plasmon-polariton mode of the multilayer structure 6. One can see that such processes are possible for this multilayer structure. The values of the optical wavelengths corresponding to the angular frequencies ω₁ and ω₂ are approximately 1.4 μm and 830 nm, respectively. The energy shift [symbol] δ has a maximum value of approximately 590 meV for [symbol] ω₀ equal to approximately 1.34 eV, corresponding to the optical wavelength 930 nm. The approximate wavelength shifts corresponding to this value of [symbol] δ are a wavelength shift of 290 nm and 720 nm and the output optical radiation of 640 nm and 1.06 μm can be obtained. For this multilayer structure there are no angular frequencies ω₀ where it is possible to have two different values for the energy shift [symbol] δ. An example of the use of this multilayer structure would be for the conversion of input optical radiation at central angular frequency ω₀, corresponding to an energy [symbol] ω₀ equal to approximately 1.34 eV, to frequency-converted optical output radiation of central angular frequencies ωₐ+δ and ω_{b}−δ with energies [symbol] (ωₐ+δ) and [symbol] (ω_{b}−δ) corresponding to energies approximately equal to 1.93 eV and 0.75 eV, respectively.

This practical example shows that the device proposed is feasible to construct. In practice the vitreous silica layer thicknesses need only be more than approximately 3 times larger or more than the titanium oxide layers for the present calculations to be of good accuracy. In practice the layer 5 can be chosen to be of millimetre order in thickness, whereas the layer 1 can be chosen to be of micron order in thickness.

The layers 1-4 can be easily produced by sputtering or vacuum deposition, for example, on a vitreous silica substrate in order to construct the multilayer structure.

The present invention is not limited to the above embodiments. Various modifications may be made within the scope of the present invention. It should be construed that the present invention covers such modifications.

This invention should be very effective in a wide range of applications in optical modulation, optical amplification or optical frequency conversion. Its versatility and optical frequency-tunability should allow it to be applied to a variety of situations in scientific, industrial and environmental applications. The invention can be used to great advantage in conjunction with pulsed or continuous lasers to widen the optical frequency range obtainable, as a optical parametric amplifier. This invention provides at the same time a means to achieve the generation of a broadband spectrum of optical frequencies from a pulsed laser, for example a supercontinuum, with particularly important applications in medicine and ultrafast spectroscopy. Furthermore, the invention provides a means to modulate optical radiation from low frequencies up to ultrahigh frequencies up to and above the terahertz range. This should be a boon in ultrafast switching applications in future telecommunications systems. The invention should also find application inside analytical equipment, such as in laser spectrometers, laser ranging systems, remote sensing systems, imaging systems, and laser power delivery systems.

1. Device for the conversion of optical radiation, comprising:
at least one incident beam of input optical radiation;
a multilayer structure containing one or more layers with a negative dielectric constant and one or more other layers with a positive dielectric constant designed so that the said multilayer structure supports at least one surface plasmon-polariton mode, and designed so that at least one of said modes allows the optical parametric interaction of two surface plasmon-polaritons of angular frequencies ωₐ and ω_{b}, resulting in the conversion to a frequency-upshifted surface plasmon-polariton with angular frequency ωₐ+δ and a surface plasmon-polariton, downshifted by an equal amount, with angular frequency ω_{b}−δ, where δ is a particular angular frequency shift or set of angular frequency shifts and one or both of said angular frequencies ωₐ and ω_{b} is an angular frequency or set of angular frequencies present in at least one of the said incident beams of input optical radiation;
means for electrical coupling into a subset of said surface plasmon-polariton modes at said angular frequencies ωₐ or ω_{b} or said angular frequencies ωₐ+δ or ω_{b}−δ of the said multilayer structure;
means for coupling said input optical radiation into one or more of said surface plasmon-polariton modes at said angular frequencies ωₐ or ω_{b} or said angular frequencies ωₐ+δ or ω_{b}−δ of the said multilayer structure;
means for coupling output optical radiation at angular frequencies ωₐ+δ or ω_{b}−δ out of the said multilayer structure;
means for coupling output optical radiation at angular frequency ωₐ and ω_{b} out of the said multilayer structure; and
means for coupling output optical radiation at angular frequencies other than ωₐ, ω_{b}, ωₐ+δ or ω_{b}−δ out of the said multilayer structure

2. Device for the conversion of optical radiation of claim 1, the said subset of said surface plasmon-polariton modes being null, so that said means for electrical coupling is absent.

3. Device for the conversion of optical radiation of claim 1, the said two surface plasmon-polaritons of angular frequencies ωₐ and ω_{b} having equal angular frequencies ωₐ=ω_{b}, which is referred to as ωₐ=ω_{b}=ω₀.

4. Device for the conversion of optical radiation of claim 1, point or points on the dispersion relation of the said surface plasmon-polariton mode or modes corresponding to the points of inflection on the said dispersion relation.

5. Device for the conversion of optical radiation of claim 1, the said incident beam or beams of input optical radiation being composed of a pulse or pulses of coherent laser radiation with a well-defined central angular frequency.

6. Device for the conversion of optical radiation of claim 1, the said incident beam or beams of input optical radiation being composed of continuous wave laser radiation with a well-defined central angular frequency.

7. Device for the conversion of optical radiation of claim 1, the said incident beam or beams of input optical radiation being composed of a combination of a pulse or pulses of coherent laser radiation with well-defined central angular frequency or frequencies and continuous wave laser radiation with well-defined central angular frequency or frequencies.

8. Device for the conversion of optical radiation of claim 1, the said means for electrical coupling into a subset of said surface plasmon-polariton modes being an electric current passed through one or more of said layers with a negative dielectric constant or one or more of said other layers with a positive dielectric constant or combinations of these.

9. Device for the conversion of optical radiation of claim 1, wherein said device is used to produce frequency-converted output optical radiation.

10. Device for the conversion of optical radiation of claim 1, the said incident beam or beams of input optical radiation being composed of a single said incident beam of input optical radiation.

11. Device for the conversion of optical radiation of claim 1, wherein the device is used to produce frequency-converted output optical radiation that is has a wider frequency spectrum than the said incident beam or beams of input optical radiation.

12. Device for the conversion of optical radiation of claim 1, wherein the said output optical radiation has a component that consists of a supercontinuum.

13. Device for the conversion of optical radiation of claim 1, wherein said device is used to modulate the frequency, amplitude, optical phase or state of polarization of at least one frequency-component of the said output optical radiation.

14. Device for the conversion of optical radiation of claim 1, the said incident beam or beams of input optical radiation being composed of two beams: an incident beam of input optical radiation with central angular frequency ω₀ and an incident beam of input optical radiation with central angular frequency ω₀+δ or ω₀−δ, where δ is a particular angular frequency shift or set of angular frequency shifts.

15. Device for the conversion of optical radiation of claim 1, wherein the said device is used to produce a said output optical radiation at angular frequencies ω+δ or ω−δ that is modulated by the said device, where δ is a particular angular frequency shift or set of angular frequency shifts, and ωₐ=ω_{b}=ω₀.

16. Device for the conversion of optical radiation of claim 1, wherein the said device is used to produce a said output optical radiation at angular frequency ω₀ that is modulated by the said device.

17. Device for the conversion of optical radiation of claim 1, the said incident beam or beams of input optical radiation being composed of three beams, an incident beam of input optical radiation with central angular frequency ω₀ and two incident beams of input optical radiation with central angular frequencies ω₀+δ and ω₀−δ, wherein the said device is used to produce said output optical radiation at angular frequency ω₀, ω₀+δ or ω₀−δ or a combination of these angular frequencies that is modulated by the said device, where δ is a particular angular frequency shift or set of angular frequency shifts, and ωₐ=ω_{b}=ω₀.

18. Device for the conversion of optical radiation of claim 1, wherein said device is used to amplify at least one frequency-component of the said input optical radiation.

19. Device for the conversion of optical radiation of claim 1, the said incident beam or beams of input optical radiation being composed of two beams, an incident beam of input optical radiation with central angular frequency ω₀ and an incident beam of input optical radiation with central angular frequency ω₀+δ or ω₀−δ wherein the said device is used to produce amplified output optical radiation at angular frequencies ω₀+δ or ω₀−δ, where δ is a particular angular frequency shift or set of angular frequency shifts, and ωₐ=ω_{b}=ω₀.

20. Device for the conversion of optical radiation of claim 1, the said multilayer structure being composed of planar layers with parallel interfaces.

21. Device for the conversion of optical radiation of claim 1, the said multilayer structure being composed of layers that possess a radius of curvature or radii of curvature.

22. Device for the conversion of optical radiation of claim 1, the said multilayer structure being composed of layers, at least one of which has a cross section in the form of a wedge.

23. Device for the conversion of optical radiation of claim 1, the said multilayer structure being composed of layers, at least one of which has the form of a waveguide with an axis oriented parallel to the layers of the said multilayer structure and bounded by two surfaces perpendicular to said layers of the said multilayer structure.

24. Device for the conversion of optical radiation of claim 1, the said axis of said waveguide being a straight line.

25. Device for the conversion of optical radiation of claim 1, the said axis of said waveguide being a curved line.

26. Device for the conversion of optical radiation of claim 1, the said layers with a negative dielectric constant of said multilayer structure being composed of metal.

27. Device for the conversion of optical radiation of claim 1, the said layers with a negative dielectric constant of said multilayer structure being composed of semiconductor or doped semiconductor.

28. Device for the conversion of optical radiation of claim 1, the said layers with a negative dielectric constant of said multilayer structure being composed of a combination of metal, semiconductor or doped semiconductor layers.

29. Device for the conversion of optical radiation of claim 1, by part of said multilayer structure being composed of a sandwich made up of a odd number of materials with one said layer with a negative dielectric constant at the centre, and with said other layers with a positive dielectric constant disposed symmetrically either side.

30. Device for the conversion of optical radiation of claim 1, part of said multilayer structure being composed of a sandwich made up of five materials in the order dielectric layer 1, dielectric layer 2, layer with a negative dielectric constant, dielectric layer 2, dielectric layer 1, where the terms dielectric layer 1 and dielectric layer 2 refer to said dielectric layers with different dielectric constants.

31. Device for the conversion of optical radiation of claim 1, the said multilayer structure being composed of layers that are thin enough for the said multilayer structure to be considered as a graded distribution of dielectric constant in the direction perpendicular to the said layers.

32. Device for the conversion of optical radiation of claim 1, the said multilayer structure being equipped with reflectors oriented perpendicular to the layers to allow the multiple reflection of said surface plasmon-polaritons inside the said multilayer structure and thus enhance the efficiency of the said device.

33. Device for the conversion of optical radiation of claim 1, the said multilayer structure being equipped with reflectors oriented perpendicular to the layers to allow the multiple reflection of said input optical radiation or said output optical radiation inside the said multilayer structure and thus enhance the efficiency of the said device.

34. Device for the conversion of optical radiation of claim 1, the said multilayer structure being equipped with reflectors, oriented parallel to the layers of the said multilayer, situated either side of the multilayer structure to allow the multiple reflection of said surface plasmon-polaritons inside the said multilayer structure and thus enhance the efficiency of the said device.

35. Device for the conversion of optical radiation of claim 1, the said multilayer structure being equipped with reflectors, oriented parallel to the layers of the said multilayer, situated either side of the multilayer structure to allow the multiple reflection of said surface plasmon-polaritons inside the said multilayer structure and thus enhance the efficiency of the said device, in which the reflectors are distributed Bragg reflectors.

36. Device for the conversion of optical radiation of claim 1, the said multilayer structure being cooled.

37. Device for the conversion of optical radiation of claim 1, the said means for coupling said input optical radiation into said surface plasmon-polariton modes including a focusing system.

38. Device for the conversion of optical radiation of claim 1, the said means for coupling said input optical radiation into said surface plasmon-polariton modes including a said focusing system in which the angular divergence of the said incident beam of input optical radiation can be varied.

39. Device for the conversion of optical radiation of claim 1, the said means for coupling said input optical radiation into said surface plasmon-polariton modes allowing the angle of incidence of the said incident beam of input optical radiation on the said multilayer structure to be varied.

40. Device for the conversion of optical radiation of claim 1, the said means for coupling said input optical radiation into said surface plasmon-polariton modes including polarizing elements to allow the use of a specific incident state of polarization of the said input optical radiation.

41. Device for the conversion of optical radiation of claim 1, the said means for coupling said input optical radiation into said surface plasmon-polariton modes including polarizing elements to allow the use of linearly polarized input optical radiation polarized in the plane of incidence.

42. Device for the conversion of optical radiation of claim 1, the said means for coupling said input optical radiation into said surface plasmon-polariton modes including a dielectric material that is placed in contact with a surface of the said multilayer structure.

43. Device for the conversion of optical radiation of claim 1, the said means for coupling said input optical radiation into said surface plasmon-polariton modes including a said dielectric material that is placed in contact with the said multilayer structure, in which this said dielectric material is in the form of a prism, hemisphere or hemicylinder.

44. Device for the conversion of optical radiation of claim 1, the said means for coupling said input optical radiation into said surface plasmon-polariton modes including a said dielectric material that is placed in contact with the said multilayer structure, in which a second dielectric material is placed between the said dielectric material and a surface of the said multilayer structure.

45. Device for the conversion of optical radiation of claim 1, the said means for coupling said input optical radiation into said surface plasmon-polariton modes including input optical radiation incident on a side of the said multilayer structure.

46. Device for the conversion of optical radiation of claim 1, the said means for coupling said input optical radiation into said surface plasmon-polariton modes including a periodic grating structure on the surface or inside the said multilayer structure.

47. Device for the conversion of optical radiation of claim 1, the said means for coupling output optical radiation out of the said multilayer structure including a focusing system used to collimate the said output optical radiation.

48. Device for the conversion of optical radiation of claim 1, the said means for coupling output optical radiation out of the said multilayer structure including a dielectric material that is placed in contact with a surface of the said multilayer structure.

49. Device for the conversion of optical radiation of claim 1, the said means for coupling output optical radiation out of the said multilayer structure including a said dielectric material that is placed in contact with the said multilayer structure, in which this said dielectric material is in the form of a prism, hemisphere or hemicylinder.

50. Device for the conversion of optical radiation of claim 1, the said means for coupling output optical radiation out of the said multilayer structure including a said dielectric material that is placed in contact with the said multilayer structure, in which a second dielectric material is placed between the said dielectric material and a surface of the said multilayer structure.

51. Device for the conversion of optical radiation of claim 1, the said means for coupling output optical radiation out of the said multilayer structure including the said output optical radiation exiting from a side of the said multilayer structure.

52. Device for the conversion of optical radiation of claim 1, the said means for coupling output optical radiation out of the said multilayer structure including a periodic grating structure on the surface or inside the said multilayer structure.

53. Device for the conversion of optical radiation of claim 1, the said means for coupling output optical radiation out of the said multilayer structure including an optical frequency filtering system.

54. Device for the conversion of optical radiation of claim 1, the said means for coupling output optical radiation out of the said multilayer structure including an element in common with the said means for coupling said input optical radiation into said surface plasmon-polariton modes of the said multilayer structure.
